(19) United States
(12) Patent Application Publication
(10) Pub. No.: US 2021/0292154 A1
(43) Pub. Date: Sep. 23, 2021

(54) Pumping station with integrated through flow counter

(71) Applicant: Lutz Pumpen GmbH, Wertheim (DE)

(72) Inventor: Andrej GETZE, Kreuzwertheim (DE)

(73) Assignee: Lutz Pumpen GmbH, Wertheim (DE)

(21) Appl. No.: 17/202,567

(22) Filed: Mar. 16, 2021

(30) Foreign Application Priority Data
Mar. 18, 2020 (DE) 10 2020 107 486.7

(51) Int. Cl. B67D 7/16; B67D 7/62; B67D 7/14; G06K 7/14

(52) U.S. Cl. CPC B67D 7/16; G06K 7/1413; B67D 7/145; B67D 7/62

(57) ABSTRACT

For a reliable determination of through flow, it is currently necessary to work with external measurement devices in the case of flow machines. In particular, in contrast to displacer machines, there is no dependence of the through flow on the speed of rotation.

In order to be able to do without an external measurement device, the present invention goes back to the use of pressure sensors, which, in combination with the collection of additional data of the motor or of the conveyed medium, allow a determination of the through flow.

The present invention relates to a pumping station for a container pump, comprising a pump pipe and an outflow nozzle that branches off from the pump pipe, which are configured, within the scope of the invention, to the effect that an integrated through flow counter is implemented on the basis of pressure sensors.

Such a pumping station is already previously known from DE 20 16 175 A. There, the work is performed using a measuring orifice, ahead of and behind which a pressure measurement is carried out. A conclusion regarding the through flow can be drawn from the pressure difference of the two measurements.

It is regularly important to obtain an overview about the amounts of a medium to be conveyed by means of a pump, in particular a container pump, that have been conveyed. For many applications, this is required for the purposes of suitable metering, for other applications it is required in order to account for specific amounts of medium being delivered. In this regard, the situation is currently such that the determination of the through flow must take place using a separate, external through flow measurement device, since integrated through flow counters have not been known until now.

The situation is different for displacer machines, in which an amount is displaced solely on the basis of the speed of rotation of the motor, and thereby a conclusion can be drawn with regard to the medium conveyed. For this reason, displacer machines can also easily make do without external measurement devices in the state of the art, and nevertheless allow a comparatively exact estimate of the through flow by way of the speed of rotation and the time.

Against this background, the present invention is based on the task of creating a pumping station for a container pump, which station allows detection of the media through flow that is turned over, without external measurement devices and without installing a measuring orifice.

This task is accomplished by means of a pumping station for a container pump in accordance with the characteristics of the independent claim 1. Practical embodiments of such container pumps can be derived from the subsequent dependent claims, in each instance.

According to the invention, it is provided that a pumping station for a container pump comprises a pump pipe, by way of which a medium can be conveyed out of a container, using a pump rotor, based on activation by means of a set on pump drive. There is an outflow nozzle at the upper end of the pump pipe, by way of which nozzle the upcoming medium can be delivered, in particular by way of a connected conveying hose, which can be closed off with a tapping device, if necessary. In order to be able to do without an external measurement device for determining the through flow, the pumping station has at least one pressure sensor, with the aid of which the pressure conditions within the pumping station can be recorded. This can take place in the pump pipe or in the outflow nozzle, or, in the case that multiple pressure sensors are used, also at both locations.

In particular, in the case of known motor parameters and parameters of the medium to be conveyed, a determination of the through flow can take place using the formula

\dot{V}ₜₕ=K₁(η,ρ)·p+c·K₂(η,ρ)

wherein K₁(η, ρ) is a correction factor as a function of the viscosity and the density, and K₂(η, ρ) is a correction factor for the maximum volume stream, and p is the measured pressure and c is the axis section of the maximum volume stream.

In order to obtain the required parameters, the control unit of the pumping station has an interface to a motor controller, which controls a motor connected with the pumping station. In particular, in this way information about the speed of rotation at which the motor is being operated, its power consumption, or, if necessary, also further parameters can be obtained.

Furthermore, receiving parameters of the medium to be conveyed is provided for, which, in a first variant, can be input directly by the user, by way of an input interface. However, it is also possible to load the data into the system by way of other means, for example by way of a barcode that is disposed on a container of the medium. By means of calling up such a barcode, the control unit can call up the data relating to the medium to be conveyed, if necessary by accessing a database or a memory unit in a local or worldwide network.

The invention described above will be explained in greater detail below, using an exemplary embodiment.

The FIGURE shows:

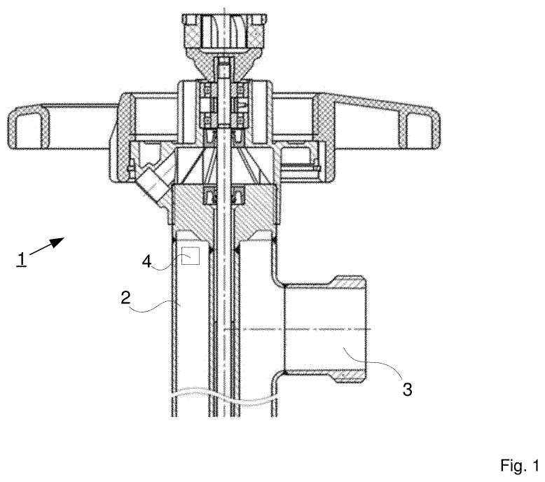

FIG. 1 a pumping station having a pressure sensor, in a cross sectional representation from the side.

FIG. 1 shows a pumping station 1, which is produced, in simplified manner, from a pump pipe 2 and an outflow nozzle 3. The outflow nozzle 3 is set onto the pump pipe 2 on the side, and conducts the medium, which is conveyed upward by means of a conveyor motor, laterally away from the pump pipe 2 into a hose line, not shown here.

In order to do without the use of an external measurement device, a through flow measurement is now supposed to take place in the pumping station 1 itself, according to the invention, with which measurement the amount of medium to be conveyed that flows through the pumping station can be determined and recorded. For this purpose, the pumping station 1 has a pressure sensor 4, which detects the pressure in its region. In addition, aside from the pressure sensor 4, another method of providing parameters from the outside is required. This takes place by way of an interface, not shown, with the connected motor, where the time can be read out from the speed of rotation of the motor and its power consumption over time. Likewise, further parameters of the fluid to be conveyed are queried by means of a further interface, wherein this can be an input means of a barcode scanner for recording and evaluating a barcode of a product label. By way of a database, the control unit can load required parameters from a memory with these additional data, and can also undertake calculation of the through flow using these data.

What is therefore described above is a pumping station for a container pump, which allows detection of the media through flow that is implemented, without external measurement devices.

### REFERENCE SYMBOL LIST

1 pumping station
2 pump pipe
3 outflow nozzle
4 pressure sensor

1. A pumping station for a container pump, comprising a pump pipe (2) and an outflow nozzle (3) branching off from the pump pipe (2), wherein at least one pressure sensor (4) is assigned to the pump pipe (2) and/or the outflow nozzle (3), which sensor transmits sensor data to a control unit for determining the through flow, wherein means for detecting motor parameters of a motor connected with the pumping station (1) as well as means for detecting media parameters of the medium conveyed by the pumping station (1) are assigned to the control unit.

2. The pumping station according to claim 1, wherein the means for detecting motor parameters is an interface for communication with a motor controller.

3. The pumping station according to claim 1, wherein the means for detecting media parameters are input means for input or selection of parameters by a user.

4: The pumping station according to claim 1, wherein the means for detecting media parameters are optical detection means, in particular a barcode scanner.

5: The pumping station according to claim 2, wherein the means for detecting media parameters are input means for input or selection of parameters by a user.

6: The pumping station according to claim 2, wherein the means for detecting media parameters are optical detection means, in particular a barcode scanner.
